(19) United States
(12) Patent Application Publication
(10) Pub. No.: US 2011/0100795 A1
(43) Pub. Date: May 5, 2011

(54) System and Method for Making Single-Walled Carbon Nanotubes

(75) Inventor: Timothy J. Imholt, Richardson, TX (US)

(73) Assignee: Raytheon Company, Waltham, MA (US)

(21) Appl. No.: 12/828,969

(22) Filed: Jul. 1, 2010

Related U.S. Application Data
(60) Provisional application No. 61/256,713, filed on Oct. 30, 2009.

(51) Int. Cl. B01J 19/08; C07B 63/00

(52) U.S. Cl. 204/158.21; 422/186; 977/742; 977/750; 977/845

(57) ABSTRACT

Purified single-walled carbon nanotubes are created by placing a sample of unpurified single-walled carbon nanotubes in a chamber and irradiating the sample of unpurified single-walled carbon nanotubes in the chamber with a microwave field. Each purified single-walled carbon nanotube created is a semiconductor.

### CROSS REFERENCE TO RELATED APPLICATIONS

This application claims the benefit of U.S. Provisional Application No. 61/256,713 filed Oct. 30, 2009 which is hereby incorporated by reference herein.

### TECHNICAL FIELD

This disclosure relates in general to nanostructure materials and more particularly to a system and method for making single-walled carbon nanotubes.

### BACKGROUND

Carbon nanotubes take on many different forms but generally fall into two groups. The first group is multi-walled carbon nanotubes (MWNT) and the second group is single-walled carbon nanotubes (SWNT). A MWNT is basically a nested formation of multi-axial layered carbon pipes with caps at either end of the cylinder structure and can be created with various chemical reactions but are commonly fabricated using a form of carbon arc discharge in the proper environment. A SWNT is essentially a rolled up graphite sheet that forms a very small thin cylinder with no seam. The fabrication of a SWNT is similar to a MWNT with the addition of a metallic catalyst. The length and diameter of a SWNT is dependent on the type of metallic catalyst used and the environmental conditions employed during fabrication.

SWNT are of interest as they could play the same role in circuits as silicon does today. The advantage of SWNT is that they form naturally much smaller than most silicon transistors. This drastic reduction is size could result in a dramatic increase in the processing speed of electronics due to the reduced distances signals would have to travel.

SWNT have been obtained in early fabrication techniques using a carbon arc chamber similar to that used for fullerene production. An anode consisting of a graphite carbon rod and a cathode consisting of a rod with a piece of iron placed in a small dimple therein are placed in the chamber that is filled with methane and argon. The SWNT were found in soot-like deposits formed during the carbon arc process. A slightly different SWNT was obtained using cobalt instead of iron and helium instead of methane and argon.

Known methods of fabrication of SWNTs result in a combination of semiconductors and conductors. Additionally, known methods of fabrication of SWNTs result in very impure nanotubes in that a low percentage of the resulting material constitutes SWNTs. The use of known fabrication methods requires extensive purification processes afterward to remove the non-SWNT structure. As the impurities are often larger than or similar in size to the SWNTs, the use of filtering in the purification process proves difficult. Furthermore, known fabrication methods are inefficient, in that only one or two grams of nanotubes are likely to be produced.

These early fabrication techniques produced impure nanotubes and only in small numbers. The catalytic materials used in SWNT fabrication prevent the large scale fairly pure production of these structures. To date, other fabrication techniques have shown little if any promise of being scaled into mass production of SWNT in either pure or impure form. In addition, all known production methods are labor and chemical intensive, thus making them very costly.

### SUMMARY OF EXAMPLE EMBODIMENTS

From the foregoing, it may be appreciated by those skilled in the art that a need has arisen to provide a technique to mass produce SWNT with a high degree of purity. In accordance with the present invention, a system and method for making single-walled nanotube structures are provided that substantially eliminate or greatly reduce disadvantages and problems associated with conventional nanotube fabrication techniques.

According to one embodiment, a method for making single-walled carbon nanotubes comprises placing a sample of unpurified single-walled carbon nanotubes in a chamber and irradiating the unpurified single-walled carbon nanotubes in the chamber with a microwave field to produce purified single-walled carbon nanotubes. Each purified single-walled carbon nanotube created is a semiconductor.

Certain embodiments of the present invention may provide numerous technical advantages. For example, a technical advantage of one embodiment may include the capability to provide a method of purification of carbon nanostructures that results in a higher level of purity of a higher quantity of carbon nanostructures than may be achieved under current purification methods. Another technical advantage of one embodiment of the present invention may include the capability to provide a purification of carbon nanostructures that results in carbon nanostructures that behave entirely as semiconductors. Yet another technical advantage of one embodiment of the present invention may be the ability to provide a method of purification that is less labor and chemical intensive than known purification means.

Although specific advantages have been enumerated above, various embodiments of the present invention may include all, some, or none of the enumerated advantages. Additionally, other technical advantages may become readily apparent to one of ordinary skill in the art after review of the following figures, description, and claims.

### BRIEF DESCRIPTION OF THE DRAWINGS

For a more complete understanding of embodiments of the present invention and advantages thereof, reference is now made to the following detailed description, taken in conjunction with the accompanying drawings, wherein like reference numerals represent like parts, in which:

FIG. 1 shows one embodiment of a system for purification of carbon nanostructures; and

FIG. 2 illustrates a graph showing microwave absorption of membrane of single-walled nanotubes according to one embodiment of the present invention.

### DETAILED DESCRIPTION

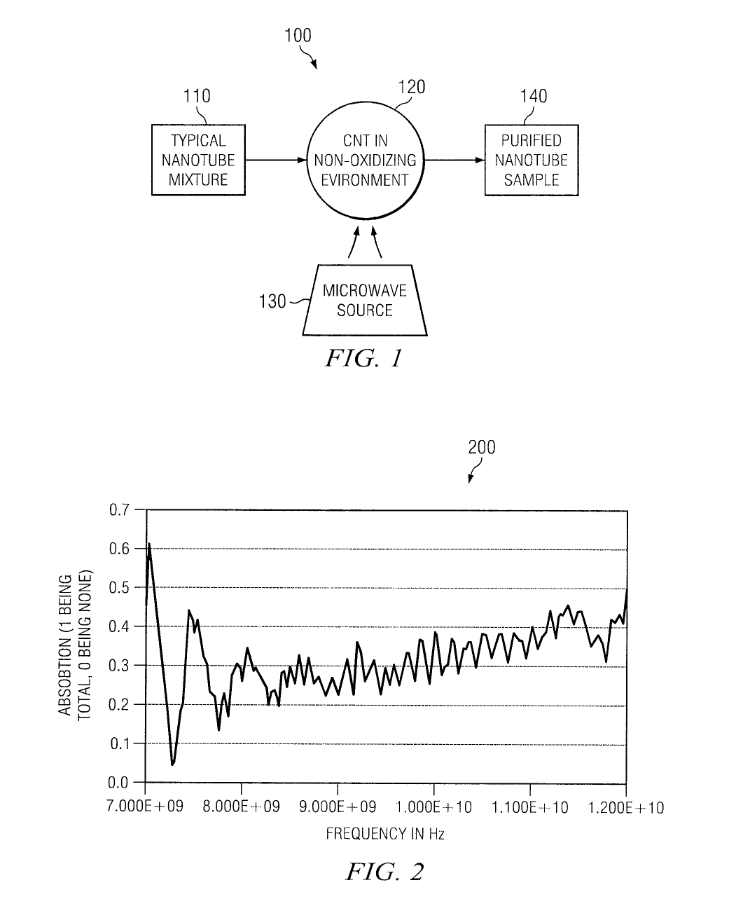

FIG. 1 shows a system 100 for purification of carbon nanostructures according to one embodiment. Generally, system 100 includes unpurified single-walled carbon nanotubes (SWNTs) 110, chamber 120, microwave radiation source 130, and purified single-walled carbon nanotubes (SWNTs) 140. Microwave radiation source 120 emits radiation onto unpurified SWNTs 110 in order to produce purified SWNTs 130. Such a system of purification may produce a resulting carbon nanostructure of a greater purity than may be achieved under known systems. Additionally, such a system of purification may produce a nanostructure consisting entirely of semiconducting SWNTs.

Unpurified SWNTs 110 are nanotubes with only a single shell of atoms. The structure of a SWNT can be conceptualized by wrapping a one-atom-thick layer of atoms into a seamless cylinder. In this manner, SWNTs can be thought of as little pipes or cylinders with diameters typically ranging from, but not limited to, approximately 0.6 to 5.0 nanometers. The lengths of SWNTs can range from a few hundred nanometers to several centimeters in length.

Currently, various techniques are available for synthesis of SWNTs, including several that grow SWNTs on a substrate or microchip in patterns as required. These techniques may result in differing characteristics, such as length, diameter, corresponding aspect ratios, electrical properties, and purity levels. The length and diameter of SWNTs depend on the metallic catalyst and environmental conditions employed during fabrication. The aspect ratio and electrical conductivity of SWNTs are particularly important, as these characteristics alter the response to the nanotubes to electromagnetic waves.

SWNTs perform similar to silicon semiconductors, except they have a tolerance for higher temperatures than silicon semiconductors. For example, SWNTs may not degrade until 2000 degrees Centigrade, far above the failure temperature for silicon semiconductors. SWNTs may be either metallic or semiconducting, depending on the diameter and chiral vector of the SWNT structure, with the chiral vector being a function of the carbon-carbon bond length of the SWNT. Semiconducting SWNTs have properties that are very near that of silicon when considering the achievable bandgap and dielectric constant. However, semiconducting SWNTs exceed silicon in terms of breakdown strength.

Several techniques exist for the fabrication of SWNTs. One such technique is the use of hydrocarbon decomposition with an iron catalyst. The use of a metallic catalyst may prevent large scale, fairly pure production of the SWNTs. However, such use allows for more simple control of the diameter and length of the resulting SWNTs than other known fabrication methods.

Purified SWNTs 140 may achieve a high purity level. Purity in a nanotube refers to how much catalyst material and carbonaceous material has been removed from the sample. In general, nanotubes may form in very impure ways, such as forming with large amounts of unformed carbon or including leftover pieces of catalyst material clinging to the nanotubes. The unformed carbon and catalyst material needs to be eliminated in order to obtain purified SWNTs. Microwave radiation is recognized herein as being a mechanism to purify SWNTs.

FIG. 2 illustrates a graph 200 showing microwave absorption of SWNTs according to one embodiment. Graph 200 illustrates the absorption spectra of buckypaper—a very thin membrane of purified SWNTs that may be 1 micrometer in thickness in some embodiments—over a range of 7-12 Giga-Hertz. The measurements were taken with a sweep source that produced 25 sweeps across the entire range, with the illustrated data points being indicative of the average of the 25 sweeps. In constructing graph 200, the transmitted and reflected power levels were summed, and the summation was subtracted from the incident voltage. The original incident voltage was then divided into the above-calculated value in order to calculate the percent of microwave signal absorbed by the buckypaper. Graph 200 shows an absorption spectra that reflects a high absorption rate by the SWNTs.

For the absorption spectra of FIG. 2, the microwave sources are very low power and typical when performing spectroscopic measurements. In order to be of commercial interest, it would be beneficial to efficiently interact nanotubes with high power microwave signals. Microwave radiation source 130 is operable to generate a high power microwave field through chamber 120. Chamber 120 may represent any suitable material adapted to contain unpurified SWNTs 110 inside such that, when a microwave field is generated by microwave radiation source 130, the microwave field heats the unpurified SWNTs 110 in order to generate purified SWNTs 140.

Microwave radiation source 130 may be any suitable type operable to develop microwave energy through a container, such as chamber 120 shown in the present embodiment. For example, in one embodiment, microwave radiation source 130 may generate microwave energy at a frequency of 2.45 Giga-Hertz with 600 Watts of power. The microwave field emitted from microwave radiation source 130 may irradiate SWNTs 110 in their raw unpurified state. In one embodiment, irradiation of unpurified SWNTs 110 may result in an ignition that produces 2 distinct materials—purified SWNTs 140 and large chunks of agglomerated catalyst material in an oxidized state. In some embodiments, this agglomerated catalyst material may be iron oxide. SWNTs 140 that were 40-50% pure may be purified using microwave radiation source 130 to obtain SWNTs up to 98% pure, giving one access to semiconductors that may remain intact up to temperatures unachievable with traditional silicon. Such purification is achieved in a single irradiating step without the use of chemicals.

In some embodiments, microwave radiation source 130 may be used to achieve purified SWNTs 140 that consists entirely of semiconducting material. Unpurified SWNTs 110 in chamber 120 that exist in a non-oxidizing environment may undergo an electronic transformation. Under thermal conditions that exceed a temperature of 3000 degrees Centigrade, a SWNT may merge with its nearest neighboring SWNT, producing an SWNT with a diameter that is the sum of the diameters of the original two SWNTs. However, if the microwave radiation source 130 ceases emitting radiation after approximately six seconds, the merging process may be incomplete. The incompletion of the merging process may result in the overlapping of the electron clouds from the neighboring SWNTs, producing purified SWNTs 140 that are entirely semiconducting due to the induced bandgap. In this manner, a semiconductor only batch of SWNT can be created.

It should be understood that, although example implementations of embodiments of the invention are illustrated herein, the present invention may be implemented using any number of techniques, whether currently known or not. The present invention should in no way be limited to the example implementations, drawings, and techniques illustrated below. Additionally, the drawings are not necessarily drawn to scale.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

To aid the Patent Office, and any readers of any patent issued on this application in interpreting the claims appended hereto, applicants wish to note that they do not intend any of the appended claims to invoke Paragraph 6 of 35 U.S.C. §112 as it exists on the date of filing hereof unless the words “means for” or “step for” are explicitly used in the particular claim.

What is claimed is:

1. A method for making single-walled carbon nanotubes comprising:
placing a sample of unpurified single-walled carbon nanotubes in a chamber; and
irradiating the sample of unpurified single-walled carbon nanotubes in the chamber with a microwave field to produce purified single-walled carbon nanotubes, each purified single-walled carbon nanotube being a semiconductor.

2. The method of claim 1, further comprising:
irradiating the unpurified single walled carbon nanotubes in the chamber until ignition occurs.

3. The method of claim 1, wherein the microwave field has a frequency of 2.45 Giga-Hertz.

4. The method of claim 1, wherein the unpurified single-walled carbon nanotubes are fabricated using a hydrocarbon decomposition with an iron catalyst.

5. The method of claim 1, further comprising:
irradiating the unpurified single-walled carbon nanotubes in the chamber until adjacent nanotubes begin to merge;
removing the microwave field prior to completion of nanotube merger.

6. A system for making single-walled carbon nanotubes, comprising:
a chamber operable to produce a sample of unpurified single-walled carbon nanotubes; and
a microwave radiation source operable to irradiate the sample of the unpurified single-walled carbon nanotubes in the chamber with a microwave field to produce purified single-walled carbon nanotubes, each purified single-walled carbon nanotube being a semiconductor.

7. The system of claim 6, wherein the microwave field has a frequency of 2.45 Giga-Hertz and operates at 600 Watts.

8. The system of claim 6, wherein the unpurified single-walled carbon nanotubes are fabricated using hydrocarbon decomposition with an iron catalyst.

9. The system of claim 6, wherein the microwave radiation source irradiates the unpurified single walled carbon nanotubes in the chamber until ignition occurs.

10. The system of claim 6, wherein the microwave radiation source provides selective radiation until adjacent nanotubes begin to merge, the microwave radiation source operable to remove the microwave field prior to completion of nanotube merger.
